(19) United States
(12) Patent Application Publication
(10) Pub. No.: US 2014/0030793 A1
(43) Pub. Date: Jan. 30, 2014

(54) BACTERIA OF THE GENUS PSEUDONOCARDIA THAT ARE CAPABLE OF DEGRADING METHYL TERT-BUTYL ETHER (MTBE) OR ETHYL TERT-BUTYL ETHER (ETBE) INTO A SOLUTION IN EFFLUENT

(71) Applicant: IFP Energies Nouvelles, Rueil-Malmaison Cedex (FR)

(72) Inventors: Yoann LE DIGABEL, Puteaux (FR); Francoise FAYOLLE-GUICHARD, Paris (FR)

(73) Assignee: IFP Energies Nouvelles, Rueil-Malmaison Cedex (FR)

(21) Appl. No.: 13/949,669

(22) Filed: Jul. 24, 2013

(30) Foreign Application Priority Data
Jul. 25, 2012 (FR) 12/02.105

(51) Int. Cl. A62D 3/02

(52) U.S. Cl. CPC A62D 3/02
USPC 435/252.1; 435/262.5

(57) ABSTRACT

This invention relates to bacteria of the genus Pseudonocardia, and in particular the strain deposited on Jul. 12, 2012 at the Pasteur Institute (CNCM, 25 rue du Docteur Roux, F-75724 PARIS Cedex 15, France) under No. CNCM 1-4656, capable of degrading MTBE and/or ETBE.

The invention also relates to a process for treatment of an effluent comprising MTBE and/or ETBE and optionally TBA that uses such bacteria.

This invention relates to microorganisms of the genus Pseudonocardia that are capable of degrading gasoline additives and in particular ethyl tert-butyl ether (ETBE) or methyl tert-butyl ether (MTBE) or tert-butyl alcohol (TBA) into a solution in water. The invention also has as its object a strain of the genus Pseudonocardia, deposited on Jul. 12, 2012 at the Pasteur Institute (CNCM, 25 rue du Docteur Roux, F-75724 PARIS Cedex 15, France) under No. CNCM 1-4656. The microorganisms according to the invention find their application in the water treatment industry.

This invention also has as its object a process for the treatment of aqueous effluent containing compounds such as ethyl tert-butyl ether (ETBE) and/or methyl tert-butyl ether (MTBE) or optionally tert-butyl alcohol (TBA) by using such microorganisms.

### STATE OF THE ART

It is known that additives are added to gasolines to improve engine performance; this is the case of oxygenated additives or ether-fuels: the methyl tert-butyl ether (referred to hereinafter as MTBE) is one of the ethers that can be used as an oxygenated additive in unleaded gasolines for the purpose of increasing the octane number thereof as well as the ethyl tert-butyl ether (referred to hereinafter as ETBE), which has preferentially been used in France and in Europe for several years because of its qualification as a biofuel. These compounds can be added to gasolines at a rate of 22% (v/v). The transport of hydrocarbons, by land or water, poses numerous accident risks. Transport via pipeline, which is generally considered safer than by truck, train or tanker, can nevertheless generate pollution. It was estimated in 2010 that the pipelines represent the most common (27%) source of spills. Ground pollution by hydrocarbons is also due to truck or train accidents during transport, accidents during the filling of service station tanks, leaks in storage tanks in service stations, or on industrial sites. In addition to these major sources of pollution by hydrocarbons, there is chronic pollution that occurs during the filling of vehicle tanks in service stations or with leaks in vehicle tanks. In these last two cases, this chronic discharging of a very small quantity into the ground water is also important. Among the compounds of the gasolines, all do not have the same toxicity and/or biodegradability, and this will determine their future in the environment. Benzene, for example, which is one of the monoaromatic compounds of the gasolines, is a compound that is very toxic but easily degraded by aerobiosis. Among the native compounds of gasolines that are resistant to biodegradation, it is possible to cite 2,2,4-trimethylpentane (referred to hereinafter as isooctane) or cyclohexane, whose toxicity levels are slightly lower.

The literature relative to the biodegradation of the compounds of gasolines or alkanes by microorganisms is important. Numerous microorganisms having capacities for degradation of these compounds have been isolated. In contrast, a more limited number of microorganisms with capacities for degradation of MTBE or ETBE, whose biodegradation is slower than that of the so-called “easily biodegradable” compounds, have been isolated. Because of the growing use of additives such as MTBE or ETBE in the formulations of gasolines or diesel fuel, it is therefore necessary to know the future of these compounds in the case of accidental spillage leading to pollution of the ground and subterranean waters or of the surface waters. This necessity is all the greater in the case of MTBE and ETBE because these compounds are very soluble in water (40 and 10 g·L⁻¹, respectively) and they are considered to be potentially toxic (in particular MTBE), and, except for any consideration of toxicity, their presence in water at very low concentrations makes the water unsuitable for consumption because of the taste that they impart thereto. Furthermore, because of their low biodegradability, the contamination by one of these compounds can lead to their persistence, like that which was recently demonstrated, for example, on a service station site contaminated by ETBE, where concentrations of up to 200 mg·L⁻¹ of ETBE were measured even after several years of treatment of the site by conventional means (sparging, . . . ), thus confirming the low effectiveness of the conventional physico-chemical means for rehabilitation of such sites [Journal of Hazardous Materials, 201-202 (2012) pp. 36-243].

One object of the invention is to propose new microorganisms that are capable of biodegrading the MTBE or ETBE that can reach acquiferous layers in cases of pollution.

### SUMMARY OF THE INVENTION

The applicant discovered, surprisingly enough, that the microorganisms of the genus Pseudonocardia had important capacities for biodegradation of MTBE and/or ETBE and/or TBA, in particular the strain Pseudonocardia deposited on Jul. 12, 2012 at the Pasteur Institute (CNCM, 25 rue du Docteur Roux, F-75724 PARIS Cedex 15) under No. CNCM 1-4656.

### DETAILED DESCRIPTION OF THE INVENTION

The applicant observed, surprisingly enough, that when ETBE or MTBE is provided to a bacterium of the genus Pseudonocardia, and in particular to the strain Pseudonocardia deposited on Jul. 12, 2012 under No. CNCM 1-4656, the former has proven capable of degrading these two compounds. The tert-butyl alcohol (TBA) that is a major intermediate product of the degradation of MTBE and ETBE is produced transitorily during the biodegradation and then is next totally consumed by this bacterium, thus proving that the bacteria according to the invention have all of the degradation enzymes, making it possible to go as far as the mineralization and the production of biomass.

The bacteria according to the invention have been isolated from microcosms that come from different environments that have been obtained by enrichment on a minimum medium containing MTBE or ETBE as a single carbon source. This protocol was carried out according to the specific microorganism enrichment techniques known to one skilled in the art.

The resulting bacterial strains have been isolated after these specific enrichment stages on petri dishes containing the rich medium conventionally used by one skilled in the art (Tripticase/soy or TS medium) but after dilution of this medium to 1/10 relative to the concentration that is conventionally used. These bacteria were then identified based on their DNA No. 16S sequence and by comparison with the databases of bacteria DNA, and then they have been tested for their capacities for degradation of ETBE and MTBE.

This invention also relates to a process for treatment of effluent containing MTBE and/or ETBE and optionally TBA, in which the effluent is brought into contact under aerobic conditions in the presence of at least one bacterial strain of the genus Pseudonocardia, and in particular the strain Pseudonocardia deposited on Jul. 12, 2012 under No. CNCM 1-4656 at the Pasteur Institute (25 rue du Docteur Roux, F-75724 PARIS Cedex 15, France).

The use of these bacteria for continuous treatment of effluent polluted by MTBE or ETBE can be carried out, for example, in a biofilter where the bacteria are fixed on a mineral or organic substrate, or else they can be added as an inoculum to sludges from a sewage treatment plant, or in any other system that is suitable for the treatment of water and soil (biobarrier).

According to an advantageous embodiment, the treatment process can use the bacteria according to the invention in combination with the bacteria that are described in the patent application FR 2 944 006, when the effluent contains a cocktail of hydrocarbon compounds such as octane, benzene, ethylbenzene, toluene, m-xylene, p-xylene, cyclohexanol, cyclohexane, and isooctane.

### BRIEF DESCRIPTION OF THE FIGURES

These aspects as well as other aspects of the invention will be clarified in the detailed description of particular embodiments of the invention, with reference being made to the drawings of the figures, in which:

FIG. 1 shows the changes in the concentration of ETBE, of TBA in the culture medium, and of CO₂ formed as a function of the contact time with the bacterium of the genus Pseudonocardia deposited on Jul. 12, 2012 under No. CNCM I-4656 at the Pasteur Institute (25 rue du Docteur Roux, F-75724 PARIS Cedex 15, France).

FIG. 2 shows the changes in the concentration of MTBE, of TBA in the culture medium, and of CO₂ formed as a function of the contact time with the bacterium of the genus Pseudonocardia deposited on Jul. 12, 2012 under No. CNCM I-4656 at the Pasteur Institute (25 rue du Docteur Roux, F-75724 PARIS Cedex 15, France).

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding application No. FR 12/02.105, filed Jul. 25, 2012, are incorporated by reference herein.

### EXAMPLES

### Example 1

### Growth of the Bacterium of the Genus Pseudonocardia Deposited On Jul. 12, 2012 Under No. CNCM 1-4656 At the Pasteur Institute (25 Rue Du Docteur Roux, F-75724 PARIS Cedex 15, France) On A Mineral Medium In the Presence of ETBE As A Single Carbon Source

A preculture of the bacterium of the genus Pseudonocardia No. CNCM 1-4656 is made: the strain Pseudonocardia No. CNCM 1-4656 is inoculated on a saline mineral medium MM supplemented with ETBE at approximately 200 mg·L⁻¹ as a source of carbon and energy.

The medium MM has the following composition:

| | | |
|---|---|---|
| KH₂PO₄ | 1.4 | g |
| K₂HPO₄ | 1.7 | g |
| NaNO₃ | 1.5 | g |
| MgSO₄, 7H₂O | 0.5 | g |
| CaCl₂, 2H₂O | 0.04 | g |
| FeCl₃, 6H₂O | 0.012 | g |
| Concentrated Solution of Vitamins | 1 | mL |
| Concentrated Solution of | 1 | mL |
| Oligoelements | | |
| H₂O | 1 | L |

The concentrated solution of vitamins has the following composition for 1 liter of distilled water:

| | |
|---|---|
| Biotin | 200 mg |
| Riboflavin | 50 mg |
| Nicotinic Acid | 50 mg |
| Pantothenate | 50 mg |
| p-Aminobenzoic Acid | 50 mg |
| Folic Acid | 20 mg |
| Thiamine | 15 mg |
| Cyanocobalamin | 1.5 mg |

The concentrated solution of oligoelements has the following composition for 1 liter of distilled water:

| | | |
|---|---|---|
| CuSO₄, 5H₂O | 0.1 | g |
| MnSO₄, 2H₂O | 1 | g |
| ZnSO₄, 7H₂O | 1 | g |
| AlCl₃, 6H₂O | 0.4 | g |
| NiCl₂, 6H₂O | 0.25 | g |
| H₃BO₃ | 0.1 | g |
| CoCl₂, 6H₂O | 1 | g |
| Na₂MoO₄, 2H₂O | 1 | g |
| Na₂WO₄, 2H₂O | 1 | g |

After growth, this preculture is used for inoculating 100 mL of a saline mineral medium (inoculation rate: 10% v/v) to which ETBE is added at a final concentration of approximately 300 mg·L⁻¹ in an Erlenmeyer flask with a 500-mL capacity, closed with a Teflon-coated plug so as to prevent any loss of ETBE during the growth. Sampling is done at time t=0 for a metering of ETBE at the beginning by gas phase chromatography analysis with a flame ionization detector (CPG/FID). The flask is then incubated at 30° C. in a rotary stifling mechanism. Sampling for the metering of the substrate and its optional degradation products is done at regular intervals. The production of CO₂ that is produced in the gaseous phase is also measured by sampling said gaseous phase through the septum with a gas-tight syringe by analysis of CO₂ by gas phase chromatography with a Katharometer-type detector (CPG/TCD).

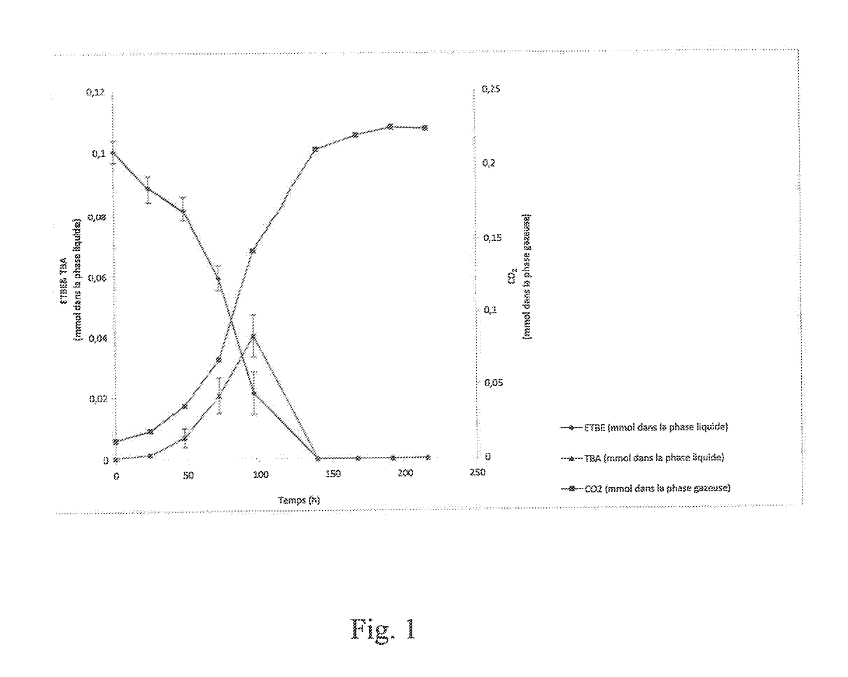

The result of this experiment is presented in FIG. 1. As is seen in this figure, ETBE is partially degraded into TBA. This compound is then itself re-consumed and used as a growth substrate.

It is possible to apply the protocol that is described above to different bacteria for evaluating their capacity to degrade ETBE and therefore makes it possible to select the bacteria that are capable of degrading ETBE.

### Example 2

### Growth of the Bacteria of the Genus Pseudonocardia Deposited On Jul. 12, 2012 Under No. CNCM 1-4656 At the Pasteur Institute (25 Rue Du Docteur Roux, F-75724 PARIS Cedex 15, France) On A Mineral Medium In the Presence of MTBE As the Single Source of Carbon

A preculture of the bacterium of the genus Pseudonocardia No. CNCM 1-4656 is made: the strain Pseudonocardia No. CNCM 1-4656 is inoculated on a saline mineral medium MM supplemented with MTBE at approximately 200 mg·L⁻¹ as a source of carbon and energy. The medium MM has the composition that is described in Example 1.

After growth, this preculture is used for inoculating 100 mL of a medium MM (inoculation rate: 10% v/v) to which MTBE is added at a final concentration of approximately 300 mg·L⁻¹ in an Erlenmeyer flask with a 500-mL capacity that is closed with a Teflon-coated plug so as to prevent any loss of MTBE during growth. Sampling is done at time t=0 for a metering of MTBE at the beginning by gas phase chromatography analysis with a flame ionization detector (CPG/FID). The flask is then incubated at 30° C. in a rotary stifling mechanism. Sampling for the metering of the substrate and its optional degradation products is done at regular intervals. The production of CO₂ that is produced in the gaseous phase is also measured by sampling said gaseous phase through the septum with a gas-tight syringe by analysis of CO₂ in gas phase chromatography with a Katharometer-type detector (CPG/TCD).

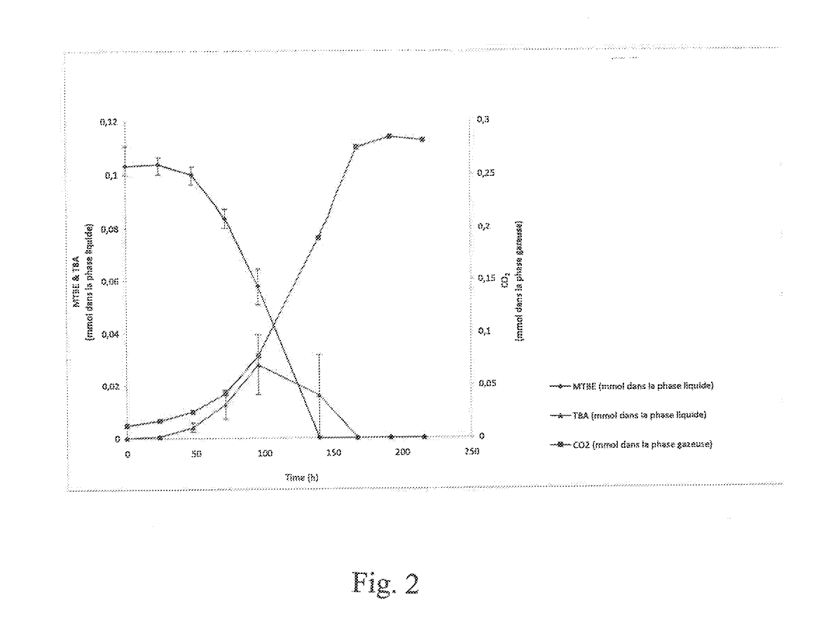

The result of this experiment is presented in FIG. 2. As is seen in this FIG. 2, the MTBE is partially degraded into TBA. This compound is then itself re-consumed and used as a growth substrate.

It is possible to apply the protocol described above to different bacteria for evaluating their capacity to degrade MTBE and therefore makes it possible to select bacteria that are capable of degrading MTBE.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### Key To FIG. 1

ETBE & TBA (mmol dans la phase liquide)=ETBE & TBA (mmol in the liquid phase)
Temps (h)=Time (h)
CO₂ (mmol dans la phase gazeuse)=CO₂ (mmol in the gaseous phase)
ETBE (mmol dans la phase liquide)=ETBE (mmol in the liquid phase)
TBA (mmol dans la phase liquide)=TBA (mmol in the liquid phase)
CO₂ (mmol dans la phase gazeuse)=CO₂ (mmol in the gaseous phase)

### Key To FIG. 2

MTBE & TBA (mmol dans la phase liquide)=MTBE & TBA (mmol in the liquid phase)
Temps (h)=Time (h)
CO₂ (mmol dans la phase gazeuse)=CO₂ (mmol in the gaseous phase)
MTBE (mmol dans la phase liquide)=MTBE (mmol in the liquid phase)
TBA (mmol dans la phase liquide)=TBA (mmol in the liquid phase)
CO₂ (mmol dans la phase gazeuse)=CO₂ (mmol in the gaseous phase)

1. Bacterium of the genus Pseudonocardia that is capable of degrading MTBE and/or ETBE.

2. Bacterium of the genus Pseudonocardia deposited on Jul. 12, 2012 under No. CNCM 1-4656 at the Pasteur Institute (25 rue du Docteur Roux, F-75724 PARIS Cedex 15, France).

3. Process for the treatment of an effluent that comprises MTBE and/or ETBE and optionally TBA as a growth substrate in which said effluent is brought into contact, under aerobic conditions, with at least one bacterium according to claim 2.

4. Process according to claim 3, in which the bacterium is fixed in a biofilter.

5. Process according to claim 4, in which the bacterium is fixed on a mineral or organic substrate.

6. Process according to claim 3, in which the effluent is brought into contact with a sewage treatment sludge containing the bacterium.
